(19) United States
(12) Patent Application Publication
(10) Pub. No.: US 2017/0144000 A1
(43) Pub. Date: May 25, 2017

(54) RESISTANCE AND FILTRATION BREATHING DEVICE

(71) Applicant: TrainingMask L.L.C., Cadillac, MI (US)

(72) Inventor: Casey Danford, Cadillac, MI (US)

(73) Assignee: TrainingMask L.L.C., Cadillac, MI (US)

(21) Appl. No.: 14/951,837

(22) Filed: Nov. 25, 2015

(51) Int. Cl. A62B 23/02; A62B 9/02; A62B 18/02; A62B 7/10

(52) U.S. Cl. CPC A62B 23/025; A62B 7/10; A62B 9/02; A62B 18/02

(57) ABSTRACT

A device includes a face mask having an exterior surface, an interior surface, a central aperture extending from the exterior surface to the interior surface, and a perimeter. The face mask is adapted to overlay a user's mouth and nose such that the perimeter forms an air-tight seal with the user's face. The device also includes an outer layer overlaying the face mask and having a pair of straps with inter-engaging ends for affixing the face mask about the user's face. The device also includes an insert adapted to be received within the central aperture of the face mask in an air-tight manner. The insert includes an exterior surface, an interior surface, a first portion adapted to prevent the user from inhaling therethrough and to allow the user to exhale therethrough, a second portion adapted to filter air inhaled therethrough, and a cap overlaying said first and second portions.

### FIELD OF THE INVENTION

The present invention relates to wearable breathing devices. More particularly, the present invention relates to wearable breathing masks providing air filtration and resistance to air inhalation.

### BACKGROUND OF THE INVENTION

Individuals who are training for physical fitness or athletic competition may wish to improve the efficiency of their cardiovascular systems for improved health and stamina. Continued exposure to the reduced concentration of oxygen in the atmosphere at higher altitudes provides increased mass of red blood cells, improved efficiency of oxygen use by the muscles, and enhanced lung performance. Individuals may wish to be able to obtain the benefits of training in any desired setting. Individuals may further wish to train in any desired setting without being affected by the air quality present in such a desired setting.

### SUMMARY OF THE INVENTION

In an embodiment, a breathing device includes a face mask having an exterior surface, an interior surface, an aperture extending from the exterior surface to the interior surface, and a perimeter. In an embodiment, the face mask is adapted to overlay a user's mouth and nose such that the perimeter forms an air-tight seal with the user's face and around the user's mouth and nose. In an embodiment, the breathing device also includes an outer layer overlaying the face mask and having a pair of straps with inter-engaging ends that are adapted to releasably engage one another for affixing the face mask to the user's face. In an embodiment, the breathing device also includes an insert positioned within the aperture of the face mask in an air-tight manner. In an embodiment, the insert includes an exterior surface, an interior surface, a first portion adapted to prevent the user from inhaling therethrough and to allow the user to exhale therethrough, a second portion adapted to filter air inhaled and exhaled therethrough, and a cap overlaying the first portion and the second portion.

In an embodiment, the insert is removably attached to the face mask. In an embodiment, the insert is integrally formed with the face mask. In an embodiment, the first portion includes at least one air outlet valve. In an embodiment, each of the at least one air outlet valve includes an aperture extending through the insert from the exterior surface of the insert to the interior surface of the insert, a biasing element disposed within the aperture of the air outlet valve, a post extending from the biasing element proximate the exterior surface of the insert, and a flexible membrane disposed on the post. In an embodiment, the flexible membrane is adapted and positioned such that, when the user of the device exhales, the flexible membrane flexes to permit exhaled air to flow through the aperture of the air outlet valve. In an embodiment, the biasing element is positioned such that, when the user of the device inhales, the biasing element retains the flexible membrane in a position wherein the flexible membrane overlaps and prevents air from flowing through the aperture of the air outlet valve. In an embodiment, the at least one air outlet valve includes a plurality of air outlet valves.

In an embodiment, the second portion includes a filter. In an embodiment, the second portion also includes at least one aperture extending through the insert from the exterior surface of the insert to the interior surface of the insert. In an embodiment, the filter is sized and shaped so as to overlap the at least one aperture of the second portion. In an embodiment, each of at least one aperture of the second portion includes a support element formed therein and adapted to prevent the filter from being drawn into the at least one aperture of the second portion. In an embodiment, the at least one aperture includes a plurality of apertures. In an embodiment, the filter includes a plurality of layers.

In an embodiment, the outer layer includes a fabric material. In an embodiment, the fabric material includes an elastic material.

In an embodiment, the cap includes a plurality of holes extending therethrough and providing a restriction of inhalation therethrough. In an embodiment, the plurality of holes are sized and shaped to provide said restriction of inhalation therethrough. In an embodiment, a quantity of said plurality of holes is selected to provide said restriction of inhalation therethrough. In an embodiment, the breathing device also includes a replacement cap interchangeable with the cap. In an embodiment, the replacement cap includes a plurality of holes extending therethrough and providing a further restriction of inhalation therethrough. The further restriction of inhalation is different from the restriction of inhalation.

In an embodiment, the first portion of the insert is a first lateral side of the insert and the second portion of the insert is a second lateral side of the insert. In an embodiment, the insert includes a ridge protruding from the exterior surface thereof. The ridge separates the first portion of the insert from the second portion of the insert.

### BRIEF DESCRIPTION OF THE DRAWINGS

Reference is made to the following detailed description of the exemplary embodiment considered in conjunction with the accompanying drawings, in which:

FIG. 1 is a front elevational view of a resistance and filtration breathing device in accordance with a first exemplary embodiment of the present invention, said device being shown as worn by a user;

FIG. 2 is a front perspective view of the resistance and filtration breathing device shown in FIG. 1, but said device being shown as detached from the user;

FIG. 3 is a rear perspective view of the resistance and filtration breathing device shown in FIG. 2;

FIG. 4A is an exploded front perspective view of selected elements of the resistance and filtration breathing device shown in FIG. 2;

FIG. 4B is an exploded rear perspective view of the elements shown in FIG. 4A;

FIG. 5 is a front elevational view of an insert of the resistance and filtration device shown in FIG. 3, showing components of the device shown in FIG. 4A as arrayed therein;

FIG. 6 is a front elevational view of a resistance and filtration breathing device in accordance with a second exemplary embodiment of the present invention, said device being shown as worn by a user;

FIG. 7 is a front perspective view of the resistance and filtration breathing device shown in FIG. 6, but said device being shown as detached from the user;

FIG. 8 is a rear perspective view of the resistance and filtration breathing device shown in FIG. 7;

FIG. 9A is an exploded front perspective view of selected elements of the resistance and filtration breathing device shown in FIG. 7, a portion of a face mask employed by the device being sectioned out;

FIG. 9B is an exploded rear perspective view of the elements shown in FIG. 9A; and

FIG. 10 is a front elevational view of an insert of the resistance and filtration device shown in FIG. 7, showing components of the device shown in FIG. 9A as arrayed therein.

### DETAILED DESCRIPTION OF THE EXEMPLARY EMBODIMENTS

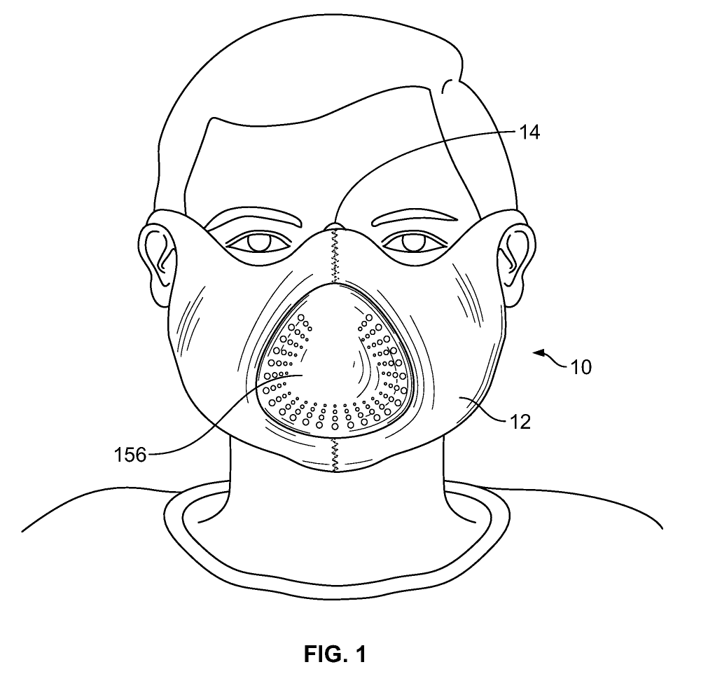

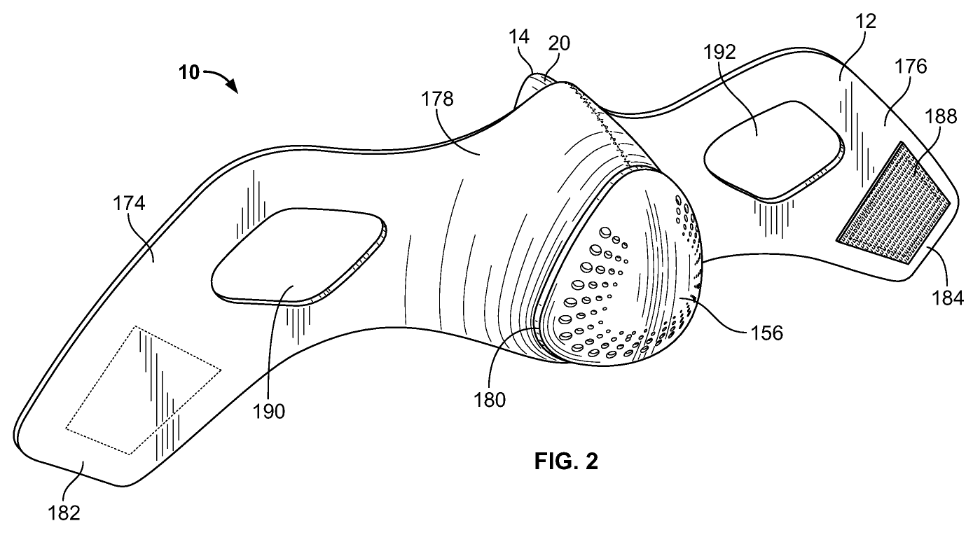

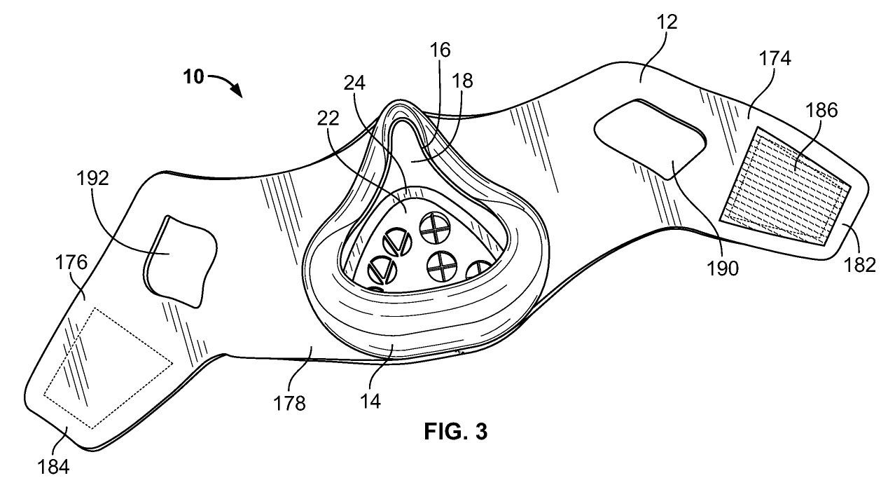

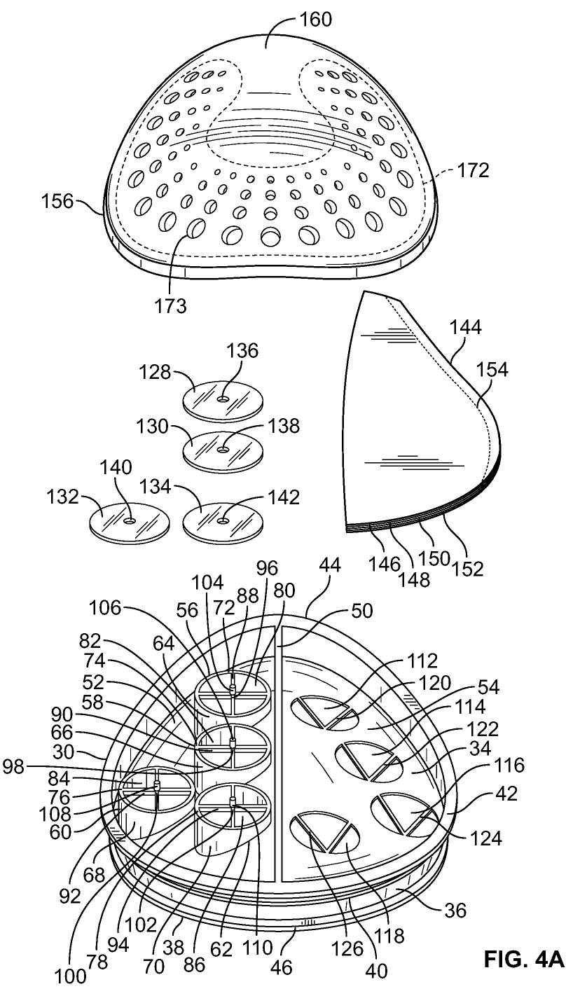

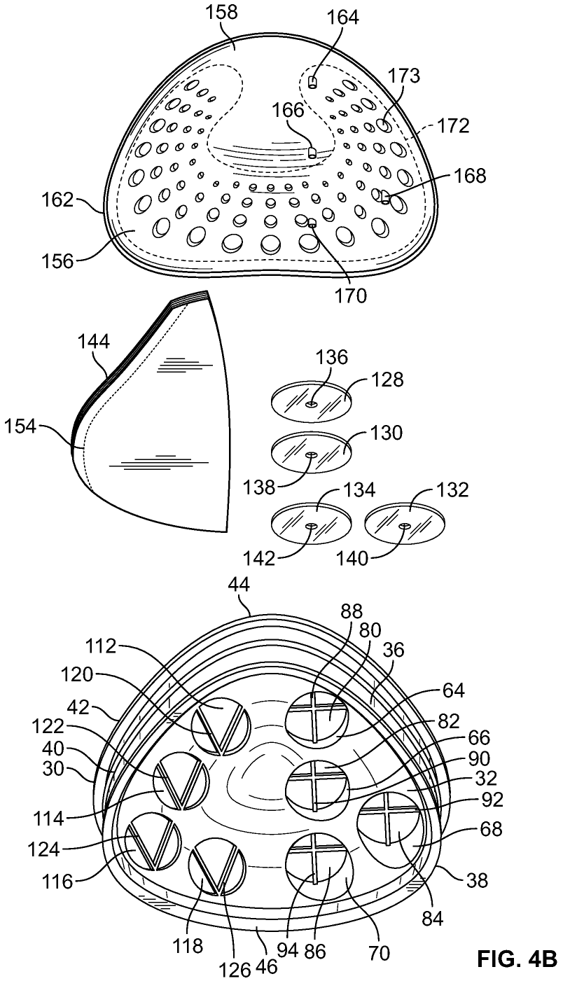

FIGS. 1-5 illustrate an exemplary resistance and filtration breathing device 10 (hereinafter “device 10”). In an embodiment, the device 10 includes an outer layer 12 overlaying a centrally-located, air-impermeable face mask 14. In an embodiment, the face mask 14 is sized, shaped, and adapted to overlay the nose and mouth of a user. In an embodiment, the face mask 14 includes a perimeter 16 (as shown in FIG. 3) that is adapted to provide an air-tight seal with a user's face. In an embodiment, the face mask 14 is made from rubber. In another embodiment, the face mask 14 is made from other suitable materials known in the art selected such that the perimeter 16 provides an air-tight seal with a user's face. Referring now to FIGS. 2 and 3, in an embodiment, the face mask 14 includes an interior surface 18 and an exterior surface 20. Referring now to FIG. 4, in an embodiment, the face mask 14 includes an aperture 22 extending from the interior surface 18 to the exterior surface 20. In an embodiment, the aperture 22 is encircled by a lip 24.

Referring now to FIGS. 4A and 4B, in an embodiment, the device 10 includes an insert 30 having an interior surface 32, an exterior surface 34, and a perimeter surface 36 encircling an entire perimeter of the interior and exterior surfaces 32, 34. In an embodiment, the insert 30 has a profile similar to a rounded triangle. In an embodiment, the insert 30 has a profile similar to that of a region overlaying a person's nose and mouth. In an embodiment, an interior flange 38 extends from the perimeter surface 36 proximate the interior surface 32. In an embodiment, an intermediate flange 40 extends from the perimeter surface 36 intermediate the interior and exterior surfaces 32, 34. In an embodiment, an exterior flange 42 extends from the perimeter surface 36 proximate the exterior surface 34. In an embodiment, the interior flange 38, intermediate flange 40, and exterior flange 42 each encircle the entire perimeter surface 36. In an embodiment, the perimeter surface 36 is sized and shaped so as to be complementary with the aperture 20 of the face mask 12. In an embodiment, the interior and intermediate flanges 38, 40 are sized, shaped, and positioned so as to retain the lip 24 of the face mask 12 therebetween and form an air-tight seal therewith. In an embodiment, the insert 30 is removably inserted into the aperture 22 of the face mask 14, so as to provide such benefits as easy cleaning and interchangeability of components of the device 10.

Continuing to refer to FIGS. 4A and 4B, in an embodiment, the perimeter surface 36 includes an upper end 44 and a lower end 46. In an embodiment, a ridge 50 protrudes from the exterior surface 34, extends from the upper end 44 to the lower end 46 of the perimeter surface 36, and divides the exterior surface 34 into a first side 52 and a second side 54. In the embodiment described herein, the exterior surface 34 is divided laterally into a first portion that is a first side 52 and a second portion that is a second side 54, but it will be apparent to those of skill in the art that other types of divisions into two portions are available, including vertically, diagonally, concentrically, etc. are possible without departing from the broader principle of the exemplary device 10.

Continuing to refer to FIGS. 4A and 4B, in an embodiment, the insert 30 includes seats 56, 58, 60, 62 disposed on the first side 52 of the exterior surface 34. It will be apparent to those of skill in the art that the inclusion of four seats 56, 58, 60, 62 is only exemplary and that other embodiments of a device 10 may include a larger or smaller quantity of seats. In an embodiment, the seats 56, 58, 60, 62 include corresponding cylindrical perimeter surfaces 64, 66, 68, 70 projecting from the exterior surface 34 of the insert 30. In an embodiment, The perimeter surfaces 64, 66, 68, 70 extends to corresponding substantially planar upper surfaces 72, 74, 76, 78 having corresponding circular apertures 80, 82, 84, 86 extending therethrough from the exterior surface 34 to the interior surface 32. In an embodiment, the seats 56, 58, 60, 62 also include corresponding biasing elements 88, 90, 92, 94 disposed within the corresponding apertures 80, 82, 84, 86 and having corresponding centers 96, 98, 100, 102. In the exemplary embodiment described herein, the biasing elements 88, 90, 92, 94 are plus-shaped, but it will be apparent to those of skill in the art that other shapes are possible. In an embodiment, the seats 56, 58, 60, 62 also include corresponding posts 104, 106, 108, 110 extending from the centers 96, 98, 100, 102 of the corresponding biasing elements 88, 90, 92, 94.

Continuing to refer to FIGS. 4A and 4B, in an embodiment, the insert 30 includes apertures 112, 114, 116, 118 formed within the second side 54 of the exterior surface 34 and extending therethrough from the exterior surface 34 to the interior surface 32. It will be apparent to those of skill in the art that the inclusion of four apertures 112, 114, 116, 118 is only exemplary and that other embodiments of a device 10 may include a larger or smaller quantity of apertures. In an embodiment, the apertures 112, 114, 116, 118 include corresponding support elements 120, 122, 124, 126 formed therein. In the exemplary embodiment described herein, the support elements 120, 122, 124, 126 are vee-shaped, but it will be apparent to those of skill in the art that other shapes are possible.

Continuing to refer to FIGS. 4A and 4B, in an embodiment, the device 10 includes flexible, air-impermeable, disc-shaped membranes 128, 130, 132, 134. Each of the membranes 128, 130, 132, 134 corresponds to one of the seats 56, 58, 60, 62; therefore, in an embodiment of a device 10 that includes a different quantity of seats, the quantity of membranes will vary accordingly. In an embodiment, the membranes 128, 130, 132, 134 include corresponding central apertures 136, 138, 140, 142, respectively, that are sized and shaped to receive the posts 104, 106, 108, 110 of the corresponding seats 56, 58, 60, 62 so as to be mounted thereon, and are sized and shaped such that, when mounted on the corresponding posts 104, 106, 108, 110, each the membranes 128, 130, 132, 134 covers the aperture 136, 138, 140, 142 of the corresponding one of the seats 56, 58, 60, 62.

Continuing to refer to FIGS. 4A and 4B, in an embodiment, the device 10 includes a filter 144 that is sized and shaped so as to be complementary to the second side 54 of the exterior surface 34 of the insert 30. In an embodiment, the filter 144 provides filtration of substantially all airborne particles from air inhaled and exhaled therethrough. In an embodiment, the filter 144 is a filter meeting the standards of the N100 class of filters defined by the National Institute for Occupational Safety and Health (“NIOSH”). In an embodiment, the filter 144 is capable of filtering at least 99.97% of airborne particles (e.g., dust, sand, etc.) in air passing therethrough. In an embodiment, the filter 144 includes layers 146, 148, 150, 152 that are affixed to one another by a binding 154. In an embodiment, the binding 154 may be formed by heat bonding. In another embodiment, the binding 154 may include stitching. However, those of skill in the art will understand that the specific aspects of the filter 144 described above (e.g., the use of a layered construction, the quantity of layers, the manner of binding of the layers) are only exemplary and that other arrangements are possible without departing from the broader concepts embodied thereby. In an embodiment, the device 10 may include two or more different interchangeable filters 144 to enable the user to customize the degree and type of filtration provided thereby. In an embodiment, the device 10 may include two or more identical interchangeable filters 144 to enable the user to replace the filter 144 after a prescribed amount of usage, to thereby maintain adequate filtration and prevent performance degradation. In an embodiment, the device 10 may include a single filter 144, but other filters may be made separately available for replacement of the included filter 144 as described above.

Continuing to refer to FIGS. 4A and 4B, in an embodiment, the device 10 includes a cap 156 having a profile similar to that of the insert 30. In an embodiment, the cap 156 has an interior surface 158 and an exterior surface 160. In an embodiment, a flange 162 extends about the entire perimeter of the interior surface 158. In an embodiment, the flange 162 is sized and shaped to be complementary to the exterior flange 42 extending from the perimeter surface 36 of the insert 30, and thereby to facilitate attachment of the cap 156 to the insert 30. In an embodiment, the cap 156 also includes cylindrical projections 164, 166, 168, 170 extending from the interior surface 158. In an embodiment, the projections 164, 166, 168, 170 are sized, shaped, and positioned such that, when the cap 156 is attached to the insert 30, each of the projections 164, 166, 168, 170 receives a corresponding one of the posts 104, 106, 108, 110, to thereby maintain corresponding ones of the membranes 128, 130, 132, 134 in desired positions on the corresponding posts 104, 106, 108, 110 and flush against the corresponding biasing elements 88, 90, 92, 94. As disclosed above with reference to the seats 56, 58, 60, 62, it will be apparent to those of skill in the art that the quantity of projections may vary among differing embodiments of the device 10. In an embodiment, the cap 156 is removably attached to the insert 30 to enable access to the internal elements of the device 10 (e.g., to enable replacement of the filter 144). In an embodiment, the cap 156 is permanently attached to the insert 30, such as through the use of an adhesive.

Continuing to refer to FIGS. 4A and 4B, in an embodiment, the cap 156 includes a hole array 172 having a plurality of holes 173, each of which extends through the cap 156 from the interior surface 158 to the exterior surface 160. FIGS. 4A and 4B indicate only a single one of the holes 173 for the sake of clarity, but it will be apparent to those of skill in the art that the disclosure of a hole 173 or of holes 173 may refer to any of the holes 173 described herein and illustrated in FIGS. 4A and 4B. It will also be apparent to those of skill in the art that the specific size, shape, and positioning of the holes 173 forming the hole array 172 shown in FIGS. 1, 2 and 4 is only exemplary. In an embodiment, the hole array 172 may restrict the passage of air therethrough to thereby provide resistance to a user's inhalation. In an embodiment, the quantity of holes 173 forming the hole array 172 may be selected to control such restriction. In an embodiment, the sizing of the holes 173 forming the hole array 172 may be selected to control such restriction. In an embodiment, the device 10 may include two or more interchangeable caps 156 to enable the user to select the degree of resistance to air inhalation. In an embodiment, the hole array 172 is arranged so as to provide an aesthetically pleasing appearance to the device 10. In an embodiment, the hole array 172 is arranged in a substantially U-shaped arrangement.

Referring back to FIGS. 2 and 3, in an embodiment, the outer layer 12 includes straps 174, 176 extending in opposite directions away from a central portion 178. In an embodiment, The central portion 178 includes an aperture 180 that is sized and shaped to surround the perimeter surface 36 of the insert 30 and retain the insert 30 therein. In an embodiment, the outer layer 12 is made from a fabric material. In an embodiment, the outer layer 12 is made from an elastic material. In an embodiment, the size of the outer layer 12 is adjustable (e.g., the lengths of the straps 174, 176 are adjustable). In an embodiment, the straps 174, 176 include corresponding ends 182, 184. In an embodiment, the ends 182, 184 of the straps 174, 176 incorporate corresponding hook and loop fasteners 186, 188 to enable the ends 182, 184 to be secured to one another, thereby to enable the device 10 to be affixed about the user's head (see, e.g., FIG. 1). In other embodiments, the ends 182, 184 of the straps 174, 176 include other securing means known in the art, such as clips, press-fit snaps, buttons, or the like. In an embodiment, the straps 174, 176 include cutouts 190, 192 for seating around the user's ears to further secure the device 10 to the user's face.

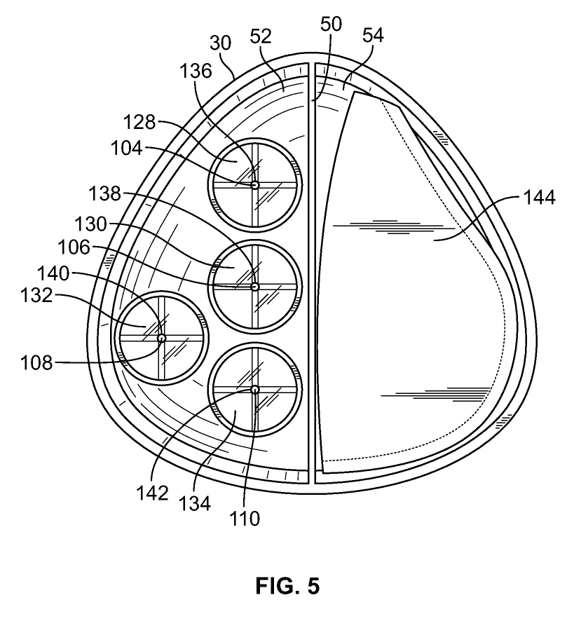

Referring now to FIG. 5, assembly of the device 10 is described. Starting with the insert 30, the membranes 128, 130, 132, 134 are affixed to the insert 30 by placing the central apertures 136, 138, 140, 142 thereof over the corresponding posts 104, 106, 108, 110. The filter 144 is placed over the second side 54 so as to cover the apertures 112, 114, 116, 118 (not shown). Once the elements of the device 10 shown in FIG. 5 have been assembled, the cap 156 is affixed to the insert 30 by engaging the flange 162 of the cap 156 with the exterior flange 42 of the insert 30. The projections 164, 166, 168, 170 of the cap 156 (see FIG. 4B) receive corresponding ones of the posts 104, 106, 108, 110 (see FIG. 4A), to thereby maintain corresponding ones of the membranes 128, 130, 132, 134 in desired positions on the corresponding posts 104, 106, 108, 110, i.e., flush against the corresponding biasing elements 88, 90, 92, 94. The presence of the cap 156 also maintains the filter 144 in close proximity to the apertures 112, 114, 116, 118 of the insert 30. The insert 30 is inserted into the aperture 22 of the face mask 14 such that the lip 24 of the face mask 14 is received between the interior flange 38 and intermediate flange 40 of the insert 30. The elastic nature of the face mask 14 retains the insert 30 within the aperture 22 in an airtight engagement. The outer layer 12 is laid over the face mask 14, which has the insert 30 retained therein. The aperture 180 of the outer layer 12 is stretched and placed over the insert 30 such that the aperture 180 surrounds the perimeter surface 36 of the insert 30, and then allowed to return to its relaxed (i.e., not stretched) size such that the aperture 180 of the outer layer 12 retains the insert 30, and thus the face mask 14, therein.

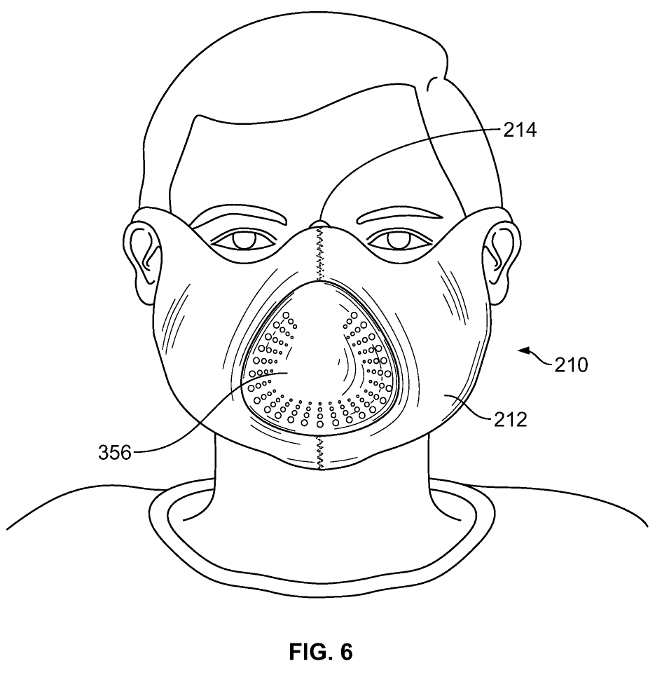

Referring now to FIGS. 6-10, it may be noted that the elements of the resistance and filtration breathing device 210 (hereinafter “device 210”) are analogous to the elements of the device 10 of FIGS. 1-5. However, the shapes and orientations of the elements may differ between the device 210 and the device 10. Therefore, elements of the device 210 are referenced by the numbers used in FIGS. 1-5 for analogous elements of the device 10, incremented by 200.

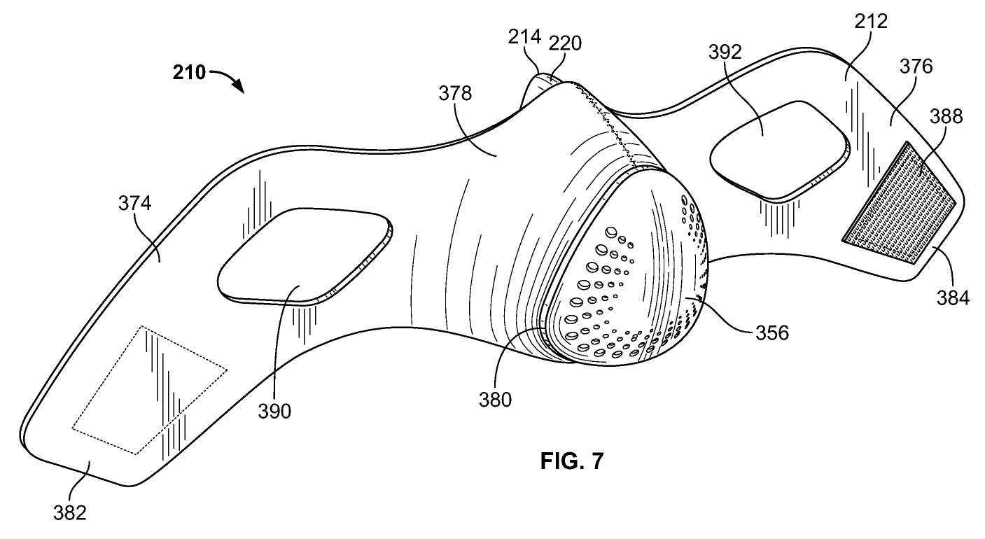

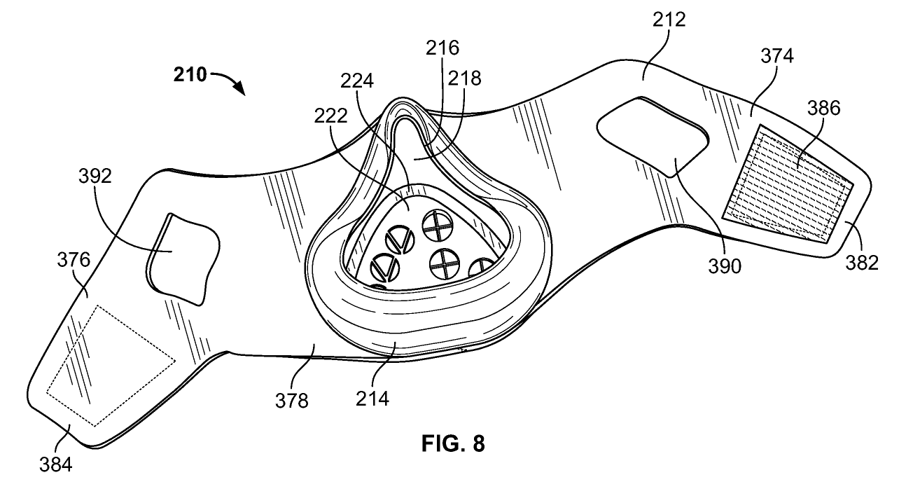

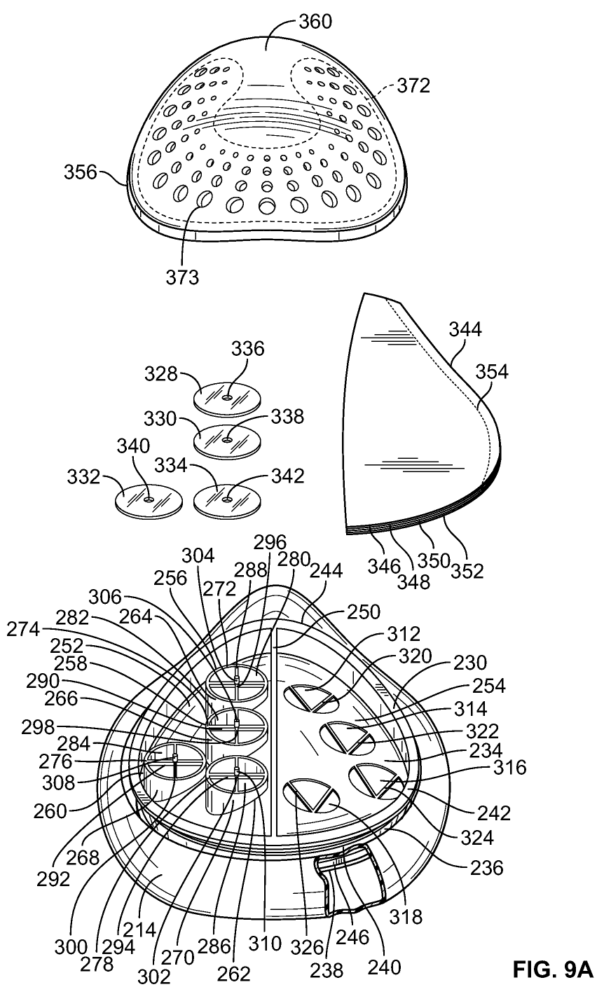

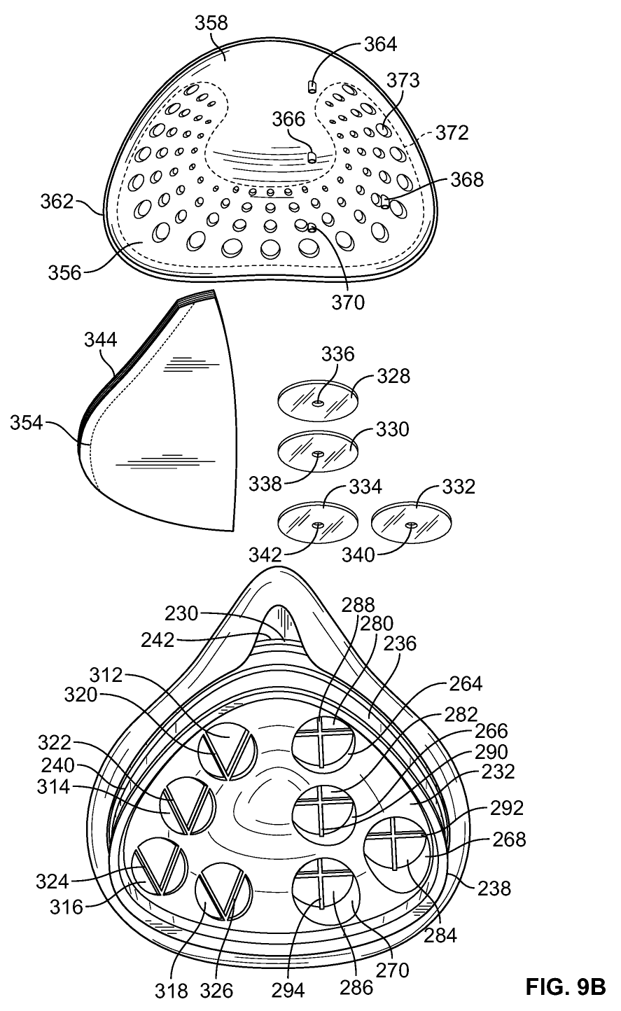

FIGS. 6-10 illustrate another exemplary resistance and filtration breathing device 210. In an embodiment, the device 210 includes an outer layer 212 overlaying a centrally-located, air-impermeable face mask 214. In an embodiment, the face mask 214 is sized, shaped, and adapted to overlay the nose and mouth of a user. In an embodiment, the face mask 214 includes a perimeter 216 (as shown in FIG. 8) that is adapted to provide an air-tight seal with a user's face. In an embodiment, the face mask 214 is made from rubber. In another embodiment, the face mask 214 is made from other suitable materials known in the art selected such that the perimeter 216 provides an air-tight seal with a user's face. Referring now to FIGS. 7 and 8, in an embodiment, the face mask 214 includes an interior surface 218 and an exterior surface 220. Referring now to FIG. 9A-9B, in an embodiment, the face mask 214 includes an aperture 222 extending from the interior surface 218 to the exterior surface 220. In an embodiment, the aperture 222 is encircled by a lip 224.

Continuing to refer to FIGS. 9A-9B, in an embodiment, the device 210 includes an insert 230 having an interior surface 232, an exterior surface 234, and a perimeter surface 236 encircling an entire perimeter of the interior and exterior surfaces 232, 234. In an embodiment, the insert 230 has a profile similar to a rounded triangle. In an embodiment, the insert 230 has a profile similar to that of a region overlaying a person's nose and mouth. In an embodiment, an interior flange 238 extends from the perimeter surface 236 proximate the interior surface 232. In an embodiment, an intermediate flange 240 extends from the perimeter surface 236 intermediate the interior and exterior surfaces 232, 234. In an embodiment, an exterior flange 242 extends from the perimeter surface 236 proximate the exterior surface 234. In an embodiment, the interior flange 238, intermediate flange 240, and exterior flange 242 each encircle the entire perimeter surface 236. In an embodiment, the perimeter surface 236 is sized and shaped so as to be complementary with the aperture 220 of the face mask 212. In an embodiment, the interior and intermediate flanges 238, 240 are sized, shaped, and positioned so as to retain the lip 224 of the face mask 212 therebetween and form an air-tight seal therewith. In an embodiment, the insert 230 is permanently affixed within the aperture 222 of the face mask 214 (e.g., attached thereto with an adhesive and/or a sealant), so as to provide such benefits as a secure airtight seal between the face mask 214 and the insert 232 and tamper-proofing of the device 210.

Continuing to refer to FIGS. 9A-9B, in an embodiment, the perimeter surface 236 includes an upper end 244 and a lower end 246. In an embodiment, a ridge 250 protrudes from the exterior surface 234 and extends from the upper end 244 of the perimeter surface 236 to the lower end 246 of the perimeter surface 236. In an embodiment, the ridge 250 divides the exterior surface 234 into a first side 252 and a second side 254. In the embodiment described herein, the exterior surface 234 is divided laterally into a first portion that is a first side 252 and a second portion that is a second side 254, but it will be apparent to those of skill in the art that other types of divisions into two portions are available, including vertically, diagonally, concentrically, etc. are possible without departing from the broader principle of the exemplary device 210.

Continuing to refer to FIGS. 9A-9B, in an embodiment, the insert 230 includes seats 256, 258, 260, 262 disposed on the first side 252 of the exterior surface 234. It will be apparent to those of skill in the art that the inclusion of four seats 256, 258, 260, 262 is only exemplary and that other embodiments of a device 210 may include a larger or smaller quantity of seats. In an embodiment, the seats 256, 258, 260, 262 include corresponding cylindrical perimeter surfaces 264, 266, 268, 270 projecting from the exterior surface 234 of the insert 230. In an embodiment, The perimeter surfaces 264, 266, 268, 270 extends to corresponding substantially planar upper surfaces 272, 274, 276, 278 having corresponding circular apertures 280, 282, 284, 286 extending therethrough from the exterior surface 234 to the interior surface 232. In an embodiment, the seats 256, 258, 260, 262 also include corresponding biasing elements 288, 290, 292, 294 disposed within the corresponding apertures 280, 282, 284, 286 and having corresponding centers 296, 298, 300, 302. In the exemplary embodiment described herein, the biasing elements 288, 290, 292, 294 are plus-shaped, but it will be apparent to those of skill in the art that other shapes are possible. In an embodiment, the seats 256, 258, 260, 262 also include corresponding posts 304, 306, 308, 310 extending from the centers 296, 298, 300, 302 of the corresponding biasing elements 288, 290, 292, 294.

Continuing to refer to FIGS. 9A-9B, in an embodiment, the insert 230 includes apertures 312, 314, 316, 318 formed within the second side 254 of the exterior surface 234 and extending therethrough from the exterior surface 234 to the interior surface 232. It will be apparent to those of skill in the art that the inclusion of four apertures 312, 314, 316, 318 is only exemplary and that other embodiments of a device 210 may include a larger or smaller quantity of apertures. In an embodiment, the apertures 312, 314, 316, 318 include corresponding support elements 320, 322, 324, 326 formed therein. In the exemplary embodiment described herein, the support elements 320, 322, 324, 326 are vee-shaped, but it will be apparent to those of skill in the art that other shapes are possible.

Continuing to refer to FIGS. 9A-9B, in an embodiment, the device 210 includes flexible, air-impermeable, disc-shaped membranes 328, 330, 332, 334. Each of the membranes 328, 330, 332, 334 corresponds to one of the seats 256, 258, 260, 262; therefore, in an embodiment of a device 210 that includes a different quantity of seats, the quantity of membranes will vary accordingly. In an embodiment, the membranes 328, 330, 332, 334 include corresponding central apertures 336, 338, 340, 342, respectively, that are sized and shaped to receive the posts 304, 306, 308, 310 of the corresponding seats 256, 258, 260, 262 so as to be mounted thereon, and are sized and shaped such that, when mounted on the corresponding posts 304, 306, 308, 310, each the membranes 328, 330, 332, 334 covers the aperture 336, 338, 340, 342 of the corresponding one of the seats 256, 258, 260, 262.

Continuing to refer to FIGS. 9A-9B, in an embodiment, the device 210 includes a filter 344 that is sized and shaped so as to be complementary to the second side 254 of the exterior surface 234 of the insert 230. In an embodiment, the filter 344 provides filtration of substantially all airborne particles from air inhaled and exhaled therethrough. In an embodiment, the filter 344 is a filter meeting the standards of the N100 class of filters defined by the NIOSH. In an embodiment, the filter 344 is capable of filtering at least 99.97% of airborne particles (e.g., dust, sand, etc.) in air passing therethrough. In an embodiment, the filter 344 includes layers 346, 348, 350, 352 that are affixed to one another by a binding 354. In an embodiment, the binding 354 may be formed by heat bonding. In another embodiment, the binding 354 may include stitching. However, those of skill in the art will understand that the specific aspects of the filter 344 described above (e.g., the use of a layered construction, the quantity of layers, the manner of binding of the layers) are only exemplary and that other arrangements are possible without departing from the broader concepts embodied thereby. In an embodiment, the device 210 may include two or more different interchangeable filters 344 to enable the user to customize the degree and type of filtration provided thereby. In an embodiment, the device 210 may include two or more identical interchangeable filters 344 to enable the user to replace the filter 344 after a prescribed amount of usage, to thereby maintain adequate filtration and prevent performance degradation. In an embodiment, the device 210 may include a single filter 344, but other filters may be made separately available for replacement of the included filter 344 as described above.

Continuing to refer to FIGS. 9A-9B, in an embodiment, the device 210 includes a cap 356 having a profile similar to that of the insert 230. In an embodiment, the cap 356 has an interior surface 358 and an exterior surface 360. In an embodiment, a flange 362 extends about the entire perimeter of the interior surface 358. In an embodiment, the flange 362 is sized and shaped to be complementary to the exterior flange 242 extending from the perimeter surface 236 of the insert 230, and thereby to facilitate attachment of the cap 356 to the insert 230. In an embodiment, the cap 356 also includes cylindrical projections 364, 366, 368, 370 extending from the interior surface 358. In an embodiment, the projections 364, 366, 368, 370 are sized, shaped, and positioned such that, when the cap 356 is attached to the insert 230, each of the projections 364, 366, 368, 370 receives a corresponding one of the posts 304, 306, 308, 310, to thereby maintain corresponding ones of the membranes 328, 330, 332, 334 in desired positions on the corresponding posts 304, 306, 308, 310 and flush against the corresponding biasing elements 288, 290, 292, 294. As disclosed above with reference to the seats 256, 258, 260, 262, it will be apparent to those of skill in the art that the quantity of projections may vary among differing embodiments of the device 210. In an embodiment, the cap 356 is removably attached to the insert 230. In an embodiment, the cap 356 is permanently attached to the insert 230, such as through the use of an adhesive.

Continuing to refer to FIGS. 9A and 9B, in an embodiment, the cap 356 includes a hole array 372 having a plurality of holes 373, each of which extends through the cap 356 from the interior surface 358 to the exterior surface 360. FIGS. 9A and 9B indicate only a single one of the holes 373 for the sake of clarity, but it will be apparent to those of skill in the art that the disclosure of a hole 373 or of holes 373 may refer to any of the holes 373 described herein and illustrated in FIGS. 9A and 9B. It will also be apparent to those of skill in the art that the specific size, shape, and positioning of the holes 373 forming the hole array 372 shown in FIGS. 6, 7, and 9A and 9B is only exemplary. In an embodiment, the hole array 372 may restrict the passage of air therethrough to thereby provide resistance to a user's inhalation. In an embodiment, the quantity of holes 373 forming the hole array 372 may be selected to control such restriction. In an embodiment, the sizing of the holes 373 forming the hole array 372 may be selected to control such restriction. In an embodiment, the device 210 may include two or more interchangeable caps 356 to enable the user to select the degree of resistance to air inhalation. In an embodiment, the hole array 372 is arranged so as to provide an aesthetically pleasing appearance to the device 210. In an embodiment, the hole array 372 is arranged in a substantially U-shaped arrangement.

Referring back to FIGS. 7 and 8, in an embodiment, the outer layer 212 includes straps 374, 376 extending in opposite directions away from a central portion 378. In an embodiment, the central portion 378 includes an aperture 380 that is sized and shaped to engage the lip 224 of the face mask 214, and thereby receive and retain the face mask 214. In an embodiment, the outer layer 212 is made from a fabric material. In an embodiment, the outer layer 212 is made from an elastic material. In an embodiment, the size of the outer layer 212 is adjustable (e.g., the lengths of the straps 374, 376 are adjustable). In an embodiment, the straps 374, 376 include corresponding ends 382, 384. In an embodiment, the ends 382, 384 of the straps 374, 376 incorporate corresponding hook and loop fasteners 386, 388 to enable the ends 382, 384 to be secured to one another, thereby to enable the device 210 to be affixed about the user's head (see, e.g., FIG. 6). In other embodiments, the ends 382, 384 of the straps 374, 376 include other securing means known in the art, such as clips, press-fit snaps, buttons, or the like. In an embodiment, the straps 374, 376 include cutouts 390, 392 for seating around the user's ears to further secure the device 210 to the user's face.

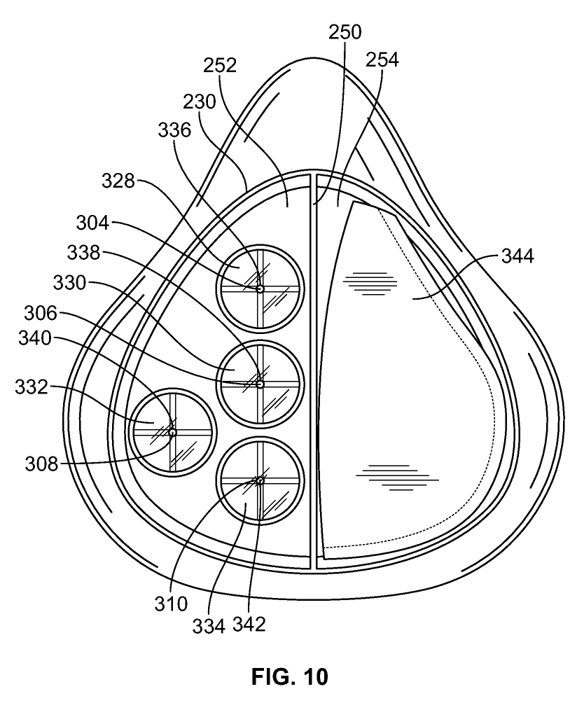

Referring now to FIG. 10, assembly of the device 210 is described. Starting with the permanently affixed combination of the face mask 214 and the insert 230, the membranes 328, 330, 332, 334 are affixed to the insert 230 by placing the central apertures 336, 338, 340, 342 thereof over the corresponding posts 304, 306, 308, 310. The filter 344 is placed over the second side 254 so as to cover the apertures 312, 314, 316, 318 (not shown). Once the elements of the device 210 shown in FIG. 5 have been assembled, the cap 356 is affixed to the insert 230 by engaging the flange 362 of the cap 356 with the exterior flange 242 of the insert 230. The projections 364, 366, 368, 370 of the cap 356 (see FIG. 9B) receive corresponding ones of the posts 304, 306, 308, 310 (see FIG. 9A), to thereby maintain corresponding ones of the membranes 328, 330, 332, 334 in desired positions on the corresponding posts 304, 306, 308, 310 and flush against the corresponding biasing elements 288, 290, 292, 294. The presence of the cap 356 also maintains the filter 344 in close proximity to the apertures 312, 314, 316, 318 of the insert 230. The outer layer 212 is laid over the face mask 214 with insert 230 permanently retained therein. The aperture 380 of the outer layer 212 is stretched and placed over the insert 230 such that the aperture 380 surrounds the perimeter surface 236 of the insert 230, and then allowed to return to its relaxed (i.e., not stretched) size such that the aperture 380 of the outer layer 212 retains the insert 230, and thus the face mask 214, therein.

Referring now to FIGS. 1-5, use of the exemplary device 10 by a user according to an exemplary embodiment will now be described. It will be apparent to those of skill in the art that the exemplary device 210 may be used in a substantially similar manner, but for brevity, only use of the exemplary device 10 will be described in detail herein. Initially, the device 10 is affixed to the user's face by placing the face mask 14 over the user's mouth and nose, passing the straps 174, 176 around either side of the user's head such that cutouts 190, 192 overlap the user's ears, and securing the ends 182, 184 to one another using the hook and loop fasteners 186, 188. The user may adjusting the hook and loop fasteners 186, 188 to ensure that the face mask 14 is pulled against the user's face with sufficient force such that the perimeter 16 is pressed tightly against the user's face and around the user's mouth and nose. By such action, an airtight seal is created between the user's face and the face mask 14, thereby ensuring that air can only pass in and out for the user's inhalation and exhalation through the various apertures formed within the insert 30.

Continuing to refer to FIGS. 1-5, when the user inhales, a reduced air pressure is induced within the face mask 14 as compared to the surrounding atmosphere. This reduced air pressure urges the membranes 128, 130, 132, 134 against the corresponding biasing elements 88, 90, 92, 94, in which position the membranes 128, 130, 132, 134 completely overlap and seal the corresponding apertures 80, 82, 84, 86. Due to such sealing, air cannot pass from the user's surroundings to within the face mask 14 through the apertures 80, 82, 84, 86.

Continuing to refer to FIGS. 1-5, also when the user inhales, the support elements 120, 122, 124, 126, disposed within the corresponding apertures 112, 114, 116, 118, prevent the filter 144 from being pulled through the apertures 112, 114, 116, 118 and to the interior of the face mask 14. Air passes from the user's surroundings to within the face mask 14 through the holes 173 of the hole array 172 of the cap 156, the filter 144, and the apertures 112, 114, 116, 118 of the second side 54 of the insert 30. The hole array 172 of the cap 156 restricts the amount of air that may flow therethrough, thereby providing resistance to the user's inhalation. Air passing in this manner is also filtered by the filter 144, and as a result airborne particulate matter (e.g., dust, sand, etc.) is filtered therefrom. Because of the air-tight seal between the perimeter 16 and the user's face, and because of the sealing of the apertures 80, 82, 84, 86 by the corresponding membranes 128, 130, 132, 134, air passing through the filter 144 is the only air that may pass from outside the device 10 to within the face mask 14 and be inhaled by the user. As a result, the user may experience resistance to inhalation, providing similar benefits to those provided by training at high altitudes. The air inhaled by the user may be substantially free of particulate matter, preventing such particulate matter from entering the user's throat and lungs and causing symptoms such as coughing and congestion.

Continuing to refer to FIGS. 1-5, when the user exhales, an increased air pressure is induced within the face mask 14 as compared to the surrounding atmosphere. This increased air pressure urges the membranes 128, 130, 132, 134 away from the corresponding biasing elements 88, 90, 92, 94, in which position the membranes 128, 130, 132, 134 do not seal the corresponding apertures 80, 82, 84, 86. Due to such lack of sealing, exhaled air can freely pass from within the face mask 14 to the user's surroundings through the apertures 80, 82, 84, 86. Exhaled air may additionally pass from within the face mask 14 through the apertures 112, 114, 116, 118 of the second side 54 of the insert 30 and through the filter 144.

The embodiments of the resistance and filtration breathing devices 10, 210 decrease the oxygen available to the body by limiting the volume of air that can be inhaled by the user during ventilation. In this regard, the devices 10, 210 simulate (i.e., as opposed to duplicating) attitude training at sea level. The user can realize benefits by having the ability to simulate a desired training stimulus without the need to travel to a training location at altitude. The user's body is unable to distinguish between a reduction in available oxygen due to an inhalation restriction and a reduction in available oxygen due to the presence of thinner air at altitude. In either case, restriction of available oxygen causes the user's body to make adaptations to adjust to the stimulus, especially if it is induced under load on a repeated basis. This adaptation results in increased serum oxygen transport to respond to the reduced oxygen state experienced during workouts.

The embodiments of the devices 10, 210 also expose the user to increased carbon dioxide content during each breathing cycle. This occurs because the air that is exhaled by the user and into the devices 10, 210 cannot fully exit the devices 10, 210 before the user inhales the next breath. Carbon dioxide tolerance is an important regulator to fatigue threshold. When the respiratory center in the brain detects an elevated concentration of CO₂ in the blood, it sends alarm signals to the breathing musculature to cause the breathing musculature to work harder. The respiratory center also creates an undesirable sensation that causes individuals to wish to cease physical efforts. Training in this state can have significant training benefits by allowing the body to endure elevated CO₂ concentrations. A lack of CO₂ tolerance is one component (along with accumulation of lactic acid and hydrogen ions) of the physical reaction often referred to as “the wall,” which causes individuals to wish to cease physical efforts. The devices 10, 210 provide the user with a means of over-inducing the physiological conditions of CO₂ elevation beyond what an athlete would normally experience.

Individuals may additionally have bad breathing habits, which are particularly difficult to break while training. It is possible to re-train oneself in proper diaphragmatic breathing in static positions, which can strengthen the diaphragm and produce proper breathing habits while relaxed. However, this rarely carries over into a training setting, as high stress levels can make individuals fall back into bad habits. Diaphragmatic breathing is important during training, because the diaphragm is the main element of the human breathing musculature. Other muscles, such as the intercostals and accessory muscles, are also involved in inspiration; however these muscles also share in core stabilization functions, making them prone to fatigue due to their multi-purpose role. The air resistance generated by the exemplary devices 10, 210 directly stresses the breathing musculature. This added load resets the motor program of the breathing muscles to favor a diaphragm-driven contraction sequence instead of a sequence that is dependent on accessory muscles. A diaphragm-driven contraction sequence is advantageous because a breathing cycle involving upper chest expansion coupled with rapid breaths, which can be observed in most people while breathing heavily, leads to decreased lung inflation and oxygen uptake, which ultimately decrease an individual's capacity to reduce oxygen debt during exertion.

Ideally, during labored breathing, breaths should be observed to originate in the abdomen; this indicates that an individual is using his or her diaphragm more rigorously. The embodiments of the devices 10, 210 help to increase the duration of inspiration during each breathing cycle, allowing the lungs more time to expand and putting the diaphragm under load through its full muscular excursion. Repeated training with the devices 10, 210 during high intensity functional activities provides functional carryover from diaphragmatic training, which cannot be replicated simply by practicing diaphragmatic breathing in a resting position. Therefore, training with the aid of the devices 10, 210 provides a functional technique for strengthening the inspiratory musculature, which directly improves performance.

The devices 10, 210 provide a comprehensive approach for the improvement of respiratory endurance. In addition to simulating altitude training through the restriction of inhaled oxygen, the devices 10, 210 can further aid the user in improving CO₂ rebreathing tolerance and in improving the conditioning of respiratory muscles.

It will be understood that the embodiments described herein are merely exemplary and that a person skilled in the art may make many variations and modifications without departing from the spirit and scope of the invention. All such variations and modifications are intended to be included within the scope of the invention, as embodied in the appended claims presented.

1. A breathing device, comprising:
a face mask having an exterior surface, an interior surface, an aperture extending from said exterior surface to said interior surface, and a perimeter, wherein said face mask is adapted to overlay a user's mouth and nose such that said perimeter forms an air-tight seal with the user's face and around the user's mouth and nose;
an outer layer overlaying said face mask and having a pair of straps with inter-engaging ends that are adapted to releasably engage one another for affixing said face mask to the user's face; and
an insert positioned within said aperture of said face mask in an air-tight manner, said insert including:
an exterior surface;
an interior surface;
a first portion adapted to prevent the user from inhaling therethrough and to allow the user to exhale therethrough;
a second portion adapted to filter air inhaled and exhaled therethrough; and
a cap overlaying said first portion and said second portion, said cap adapted to provide resistance to inhalation therethrough.

2. The breathing device of claim 1, wherein said insert is removably attached to said face mask.

3. The breathing device of claim 1, wherein said insert is integrally formed with said face mask.

4. The breathing device of claim 1, wherein said first portion includes at least one air outlet valve.

5. The breathing device of claim 4, wherein each of said at least one air outlet valve includes an aperture extending through said insert from said exterior surface of said insert to said interior surface of said insert, a biasing element disposed within said aperture of said air outlet valve, a post extending from said biasing element proximate said exterior surface of said insert, and a flexible membrane disposed on said post.

6. The breathing device of claim 5, wherein said flexible membrane is adapted and positioned such that, when the user of said device exhales, said flexible membrane flexes to permit exhaled air to flow through said aperture of said air outlet valve, and wherein said biasing element is positioned such that, when the user of said device inhales, said biasing element retains said flexible membrane in a position wherein said flexible membrane overlaps and prevents air from flowing through said aperture of said air outlet valve.

7. The breathing device of claim 4, wherein said at least one air outlet valve includes a plurality of air outlet valves.

8. The breathing device of claim 4, wherein said second portion includes a filter.

9. The breathing device of claim 8, wherein said second portion further includes at least one aperture extending through said insert from said exterior surface of said insert to said interior surface of said insert, said filter being sized and shaped so as to overlap said at least one aperture of said second portion.

10. The breathing device of claim 9, wherein each of said at least one aperture of said second portion includes a support element formed therein and adapted to prevent said filter from being drawn into said at least one aperture of said second portion.

11. The breathing device of claim 9, wherein said at least one aperture includes a plurality of apertures.

12. The breathing device of claim 8, wherein said filter includes a plurality of layers.

13. The breathing device of claim 1, wherein said outer layer includes a fabric material.

14. The breathing device of claim 13, wherein said fabric material includes an elastic material.

15. The breathing device of claim 1, wherein said cap includes a plurality of holes extending therethrough and providing a restriction of inhalation therethrough.

16. The breathing device of claim 15, wherein said plurality of holes are sized and shaped to provide said restriction of inhalation therethrough.

17. The breathing device of claim 15, wherein a quantity of said plurality of holes is selected to provide said restriction of inhalation therethrough.

18. The breathing device of claim 15, further comprising a replacement cap interchangeable with said cap, said replacement cap including a plurality of holes extending therethrough and providing a further restriction of inhalation therethrough, said further restriction of inhalation being different from said restriction of inhalation.

19. The breathing device of claim 1, wherein said first portion of said insert is a first lateral side of said insert and said second portion of said insert is a second lateral side of said insert.

20. The breathing device of claim 18, wherein said insert includes a ridge protruding from said exterior surface thereof, said ridge separating said first portion of said insert from said second portion of said insert.
